(19) United States
(12) Patent Application Publication
(10) Pub. No.: US 2009/0188400 A1
(43) Pub. Date: Jul. 30, 2009

(54) METHOD FOR GENERATING COLOR INFORMATION, SUCH AS MOTIFS, ON A SUBSTRATE MADE OF GLASS IN PARTICULAR

(76) Inventor: Rudolf Fleischle, Brackenheim (DE)

Correspondence Address: STRIKER, STRIKER & STENBY, 103 EAST NECK ROAD, HUNTINGTON, NY, 11743, US

(21) Appl. No.: 11/954,636

(22) Filed: Dec. 12, 2007

(51) Int. Cl. B41M 1/12

(52) U.S. Cl. 101/129

(57) ABSTRACT

The invention relates to a method for generating color information, such as motifs, on a substrate (16) made in particular of glass, in which a ceramic ink (17) is applied to the entire surface of one side (14) of the substrate (16). In this method, after the drying of the ink (17), at least one high-energy beam (15) is aimed at the ink and thus partly removes or fixes the ink (17) in accordance with the information to be generated.

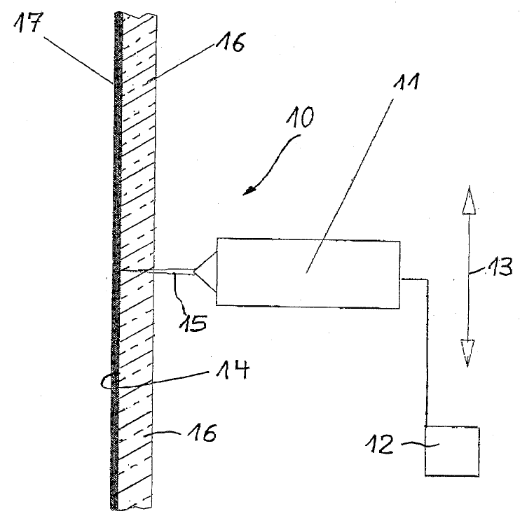

### FIELD OF THE INVENTION

The invention relates to a method for generating color information, such as motifs, on a substrate, in particular made of glass, in which a ceramic ink is applied to the full surface of one side of the substrate.

### BACKGROUND OF THE INVENTION

In screenprinting, it is known to apply inks to a substrate and thereby to form structures, such as motifs. The advantages of the known screenprinting process are widely acknowledged. However, a disadvantage of this process is that very expensive printing templates are required, which moreover have only a relatively short service life. The requisite cleaning of the screens is also complicated and is moreover environmentally polluting. The long setup times necessary in screenprinting machines are another disadvantage. Misprints cannot be precluded entirely. When motifs with various shades of color are printed, problems of accuracy often arise, since the shades of color do not always fit one another exactly and without offset.

### OBJECT AND SUMMARY OF THE INVENTION

The object of the invention is to create a method for generating color information, such as motifs, on a substrate made in particular of glass that avoids the disadvantages of screenprinting in many respects.

In a method of the type described at the outset, this object is attained according to the invention by the characteristics in claim 1. Other particular characteristics of the invention as well as advantageous features of this method will become apparent from claims 2 through 14.

As inks in the method of the invention, ceramic inks, preferably water-soluble inks that contain quartz particles, can be used. These inks are applied to the full surface of the substrate, and thanks to the method of the invention it is possible to apply motifs to the substrate. The full-surface application of the ink to the substrate can be done substantially faster and more economically than by screenprinting. Once the applied ink has dried by means of thermal action, the color coat is in a state in which it can easily be scratched off from the substrate. Since the ceramic ink contains quartz particles, this kind of mechanical removal of the ink from the substrate in order to create motifs cannot be done; because of the quartz particles contained in the ceramic ink, any tools used for attempts at removal will immediately become dull and damaged. Nor can it be precluded that the substrate, in particular made of glass, will become scratched and damaged. The invention is based on the recognition that a substrate printed with ceramic ink and made in particular from glass can have its coating partly removed, after the ink has dried, in such a way that at least one high-energy beam, in particular an energy beam of a laser, is aimed at the ink and focused at the particular point of the substrate where the ink is to be removed by this high-energy beam. Because of the action of the at least one high-energy beam, the ink is converted into powder at the point acted upon and detaches from the substrate, so that this powder can be removed by being blown off, vacuumed off, or the like, without simultaneously damaging the other color regions adhering to the substrate or detaching them from the substrate. By suitable control of the high-energy beam, it is thus possible by partial removal of the ink to generate color information, such as written material, pictures, or the like, quickly, simply, and economically. Virtually arbitrary motifs, even multilayer motifs, can be produced. Compared to the conventional screenprinting process, the method of the invention has multiple advantages. First, the very expensive printing templates that are used in screenprinting and that have only a short service life are no longer needed. This reduces expenses, because the screens, shipping them, and caring for them are eliminated; since such screens require complicated cleaning, the cleaning operation is also eliminated, with the attendant environmental advantage. The setup time for performing the method according to the invention is considerably shorter, compared to screenprinting. Misprints are practically precluded. The labor cost, especially during the irradiation with the at least one high-energy beam, is reduced. It is also advantageous that motifs with different shades of color and that fit exactly and without offset on one another can be produced without mistakes.

In an alternative method for generating color information, such as motifs, on a substrate made in particular of glass, the procedure is advantageously different. A ceramic ink is applied to the full surface of one side of the substrate, in particular the front side. After the ink has dried, at least one high-energy beam, such as a laser beam, is aimed at the ink and the predetermined information is thus fixed on the substrate at an operating temperature for instance of approximately 400° C. to 500° C. After that, the other ink regions not affected by the high-energy beam are removed, for instance by being washed off. The other color regions that are not to be removed and that form the information continue to adhere to the substrate, but this adhesive bond is not scratchproof. Advantageously, the ink can be applied to the front side of the substrate, and the at least one high-energy beam can be aimed at the front side of the substrate or the top side of the color coat. After the other color regions that are not affected by the high-energy beam are removed, for instance by being washed off, the ink remaining on the substrate is advantageously burned in by means of heat treatment. This is advantageously done by curing this ink.

Another subject of the invention is a device for generating color information, such as motifs, on a substrate made in particular of glass, having the further characteristics recited in claim 18. Further inventive characteristics and features of this device are recited in claims 19 through 21. Such a device is relatively economical, easy to manipulate, and compared to screenprinting avoids the complicated elements required for screenprinting.

Further details and advantages of the invention will become apparent from the ensuing description.

Solely to avoid unnecessary repetition, the full wording of the claims has not been given above, and they are referred to merely by number instead, but all these claims characteristics are expressly considered at this point to be disclosed as essential to the invention. All the characteristics mentioned above and in the ensuing description, as well as characteristics that can be learned solely from the drawings, are also components of the invention, even if they are not emphasized particularly and especially even if they are not mentioned in the claims.

### BRIEF DESCRIPTION OF THE DRAWING

The invention is described in further detail below in terms of an exemplary embodiment shown in the drawing. The sole drawing FIGURE is a schematic view, partly in section, of a device for generating color information, such as motifs, on a substrate made in particular of glass.

### DESCRIPTION OF THE PREFERRED EMBODIMENT

In detail, the device 10 has at least one high-energy beam generator in the form of a laser beam generator 11, which is moved by means of an actuating and control device 12, indicated only schematically, in the direction of the vertical arrow 13 and as needed transversely to that, in such a way that its laser beam 15, focused at a face 14, writes the desired information, such as motifs, on this face 14.

This face 14 is the side of a substrate 16, made in particular of glass, that faces away from the laser beam generator 11. A ceramic ink in the form of at least one color coat 17 has been applied to the full surface of this face 14 of the substrate 16 made in particular of glass, for instance by being rolled or printed onto the face 14 of the substrate 16. After this application, the ink 17 has been dried by means of thermal action, in particular infrared action, which is done in a single-pass infrared oven. In this state after the drying of the ink 17, the substrate 16, which in the drawing is suitably held in a vertical or horizontal orientation, is located such that the back face 14 is oriented for instance approximately perpendicular to the laser beam 15. The laser beam 15 is aimed through the substrate onto the ink 17, and as a result, at the particular point focused on, the ink 17 is partly removed in accordance with the particular information to be generated. As the laser beam generator 11 and laser beam 15, a laser beam generator and a laser beam of the kind that passes nondestructively through the glass substrate 16, or in other words that does not recognize glass is used. By suitable control and movement of the laser beam 15 or laser beam generator 11 by means of the device 12, arbitrary motifs with different shades of color, which fit exactly on one another without any offset whatever relative to one another, can be produced as the color information. The removal of the coat or coats of ink 17 on the back face 14 in the area of the focus at the time of the laser beam 15 is done by blasting off, and as a result instead of ink, powder occurs. This powder is removed by means of devices not shown further, for instance being blown off by means of a compressed air generator or vacuumed off by means of a suction generator.

Once desired color information, such as motifs, have been produced in the manner described on the back face 14 of the substrate 16 by means of at least partial removal of the ink 17 there, the ink remaining on the substrate 16 is fixed thereon. This is done by thermal action; the ink 17 is burned in by means of fusing and curing. For this purpose, the substrate 16 is placed in a curing oven, in which the substrate 16 is subjected to heat action, for instance at approximately 630° C. After that, the substrate 16 is cooled down, for instance with cold air.

In the exemplary embodiment shown, the substrate 16 is plane. At a point not shown, it may also have curved regions, specifically both convex and concave regions. Instead, the entire substrate may be correspondingly curved. The method according to the invention and the device 10 for performing this method thus make it possible to generate color information even on curved faces of the substrate 16, which is not possible with the known screenprinting process.

In another, alternative method for generating color information, such as motifs, on a substrate 16 that is preferably of glass, a ceramic ink 17 is applied to the full surface of the front side, located on the right in the drawing, of the substrate 16. After the ink 17 has dried, at least one high-energy beam 15, in particular a laser beam, is aimed at the ink 17. This can be done at an operating temperature of for instance approximately 400° C. to 500° C. As a result, the predetermined information is applied to the front side, located on the right in the drawing, of the substrate 16 and fixed by heat action at least to such an extent that the information continues to adhere to the substrate 16. After that, the other color regions not affected by the high-energy beam 15 are removed, for instance by being washed off. Advantageously, in this alternative method, the at least one high-energy beam 15, in particular a laser beam, is aimed at the front side, on the right in the drawing, of the substrate 16 or at the top side located to the right of that of the layer of ink 17. After the washing operation, the ink 17 that remains on the substrate 16 is burned in and cured by means of heat treatment. This alternative method is especially simple and proves to be economical for durably applying color information quickly, simply, reliably and replicably to a substrate 16 that in particular is of glass.

What is claimed is:

1. A method for generating color information, such as motifs, on a substrate (16) made in particular of glass, in which a ceramic ink (17) is applied to the entire surface of one side (14) of the substrate (16),
wherein after the ink (17) has dried, at least one high-energy beam (15) is aimed at the ink (17) and the ink (17) is thus partly removed in accordance with the information to be generated.

2. The method as defined by claim 1,
wherein the at least one high-energy beam (15) is aimed through the substrate (16) to its side (14) that carries the ink (17).

3. The method as defined by claim 1,
wherein as the high-energy beam (15), at least one energy beam of a laser (11) is aimed at the ink (17).

4. The method as defined by claim 3,
wherein as the at least one laser beam (15), a laser beam is used of the kind that passes nondestructively through the substrate (16) and in particular does not detect glass.

5. The method as defined by claim 1,
wherein the ink (17) is applied by being rolled onto the substrate (16).

6. The method as defined by claim 1,
wherein the applied ink (17), before its partial removal by means of the at least one high-energy beam (15), dries by means of thermal action, in particular infrared action.

7. The method as defined by claim 1,
wherein color information is produced from a plurality of color coats (17).

8. The method as defined by claim 1,
wherein as the color information, arbitrary motifs with different shades of color, which fit on one another without offset, are produced.

9. The method as defined by claim 1,
wherein the partial removal of the ink (17) is effected by removing a coat or coats of ink by means of the at least one high-energy beam (15).

10. The method as defined by claim 1,
wherein the partial removal of the ink (17) is effected by blasting it off by means of the at least one high-energy beam (15).

11. The method as defined by claim 1,
wherein the partially removed ink occurs in the form of powder; and this powder is removed by being blown off, vacuumed off, or the like.

12. The method as defined by claim 1,
wherein after the partial removal of ink (17), the ink remaining on the substrate (16) is burned in by means of thermal action.

13. The method as defined by claim 12,
wherein the burning in is effected by means of fusing and curing.

14. The method as defined by claim 1,
wherein the substrate (16) is plane and/or curved.

15. A method for generating color information, such as motifs, on a substrate (16) made in particular of glass, in which a ceramic ink (17) is applied to the entire surface of one side (14) of the substrate (16), in particular having the characteristics of claim 1,
wherein after the drying of the ink (17), at least one high-energy beam (15) is aimed at the ink (17) and thus, at an operating temperature for instance of approximately 400° C. to 500° C., the predetermined information is fixed on the substrate (16); and after that the other color areas, not affected by the high-energy beam (15), are removed, for instance by being washed off.

16. The method as defined by claim 15,
wherein the ink (17) is applied to the front side of the substrate (16), and the at least one high-energy beam (15) is aimed at the front side of the substrate (16) or the top side of the color coat.

17. The method as defined by claim 15,
wherein the ink (17) remaining on the substrate (16) is burned in by means of heat treatment.

18. A device for generating color information, such as motifs, on a substrate (16) made in particular of glass, in which a ceramic ink (17) is applied to the entire surface of one side (14) of the substrate (16), in particular for performing the method as defined by claim 1,
characterized by at least one high-energy beam generator (11), in particular a laser beam generator, whose energy beam (15) is aimed at the ink (17) in accordance with the color information to be generated and by that means the ink (17) is partially removed in accordance with the information to be generated.

19. The device as defined by claim 18,
wherein the high-energy beam generator (11) is located on the side of the substrate (16) that is diametrically opposite the side (14) that carries the ink (17), and is operative through the substrate (16) from that side.

20. The device as defined by claim 18,
characterized by an infrared drying device for drying the ink (17), applied to the substrate (16), before the partial removal of the ink.

21. The device as defined by claim 18,
characterized by a heat-treatment device, such as a curing oven, for burning in the ink (17), remaining on the substrate (16) after the partial removal, by heat action, for instance at approximately 630° C.
